(19) United States
(12) Patent Application Publication
(10) Pub. No.: US 2026/0361019 A1
(43) Pub. Date: Nov. 12, 2026

(54) Angled Multi-Pole Plug-In Connector

(71) Applicant: Lisa Dräxlmaier GmbH, Vilsbiburg (DE)

(72) Inventors: Stefan WIMMER, Hohenthann (DE); Franziska NEUMAYER, Geisenhausen (DE)

(73) Assignee: Lisa Dräxlmaier GmbH, Vilsbiburg (DE)

(21) Appl. No.: 19/102,050

(22) PCT Filed: Jul. 23, 2023
(86) PCT No.: PCT/EP2023/070203

§ 371 Date: Feb. 7, 2025

(30) Foreign Application Priority Data
Aug. 12, 2022 (DE) 10 2022 120 486.3

(51) Int. Cl. H01R 13/506; H01R 13/52; H01R 13/58; H01R 13/6593

(52) U.S. Cl. CPC H01R 13/506; H01R 13/5205; H01R 13/5825; H01R 13/6593

(57) ABSTRACT

This disclosure is directed to an angled plug-in connector for fastening to a shielded line. The plug-in connector has an upper housing part and a lower housing part. The upper housing part has a hole which is designed to receive the line, wherein the hole is designed to permit a pivoting movement of the upper housing part about the line and a displacement of the upper housing part along the line. The lower housing part is designed to receive at least one plug-in contact which is attached to one end of the line, and the plug-in connector has a latching mechanism which is designed to connect the upper housing part to the lower housing part.

### CROSS REFERENCE TO RELATED APPLICATIONS

This application is a national stage entry of international application PCT/EP2023/070203, filed Jul. 20, 2023, which claims priority to German patent application 102022120486.3, filed Aug. 12, 2022, the content of the both of which is incorporated herein by reference.

### BACKGROUND OF THE INVENTION

### Field of the Invention

The present invention relates to an angled plug connector for attachment to a shielded cable. The invention also relates to a method for attaching an angled connector to a shielded cable.

### Description of Related Art

There is increased demand these days, particularly in the field of electromobility for charging cables and the associated connectors. These must meet the highest sealing requirements in order to withstand environmental influences and enable outdoor charging. The connectors can preferably be designed with an angled cable outlet to ensure space-saving cable routing and convenient handling. The assembly of the connector on the cable, particularly with the angled cable outlet on a multi-pole cable, has not been possible in a satisfactory manner to date. There is therefore a need for an improved angled connector for attachment to a shielded cable, which enables a simplified assembly process.

DE 10 2015 113833 A1 also discloses an angled connector, although the assembly of the multipolar cable disclosed therein with the associated plug contacts and the remaining assemblies of the angled connector appears to be very complex. In contrast, DE 20 2021 101740 U1 discloses a plurality of individual conductors, each of which is individually guided through a housing bore of a housing part of an angled plug connector and is thus correspondingly difficult to handle. Flexible single conductors provided with a plug connector, which obviously do not have to withstand significant environmental influences, are disclosed by DE 10 2012 009887 A1. The angled plug connector disclosed in EP 2 323 228 A2 also apparently does not have to withstand significant environmental influences, with the flexibility of the cable within the housing apparently being relied upon to allow it to be customized.

DE10 2008 004801 A1, EP 1 883 135 A1, EP 2 560 249 A1 AND DE 10 2010 002176 A1 also each disclose correspondingly angled plug connectors, whereby in particular DE 10 2008 004801 A1 and EP 1 883 135 A1 each describe angled shielding elements that which then have to be arranged within corresponding housing parts, while according to DE 10 2010 002176 A1, a line inserted into a bore of a housing is subsequently bent through a lateral housing opening by means of strain reliefs, partially following the angle of the angled plug connector. EP 1 883 135 A1 relies on an elaborate, obliquely arranged sealing surface of two housing parts, which makes it possible to insert the angled shielding element straight into an upper housing part. By contrast, DE 10 2008 004801 A1 and EP 2 560 249 A1 rely on the flexibility of the cable to insert the angled shielding element into an upper housing part.

### BRIEF SUMMARY OF THE INVENTION

One task of the invention is therefore to provide an improved angled connector which can be easily attached to a cable.

The embodiments described apply equally to the angled connector for attachment to a shielded cable and the method of attaching the connector to a shielded cable for attachment of an angled connector to a shielded cable. Synergetic effects can from various combinations of the embodiments, even if they are not described in detail.

Furthermore, it should be pointed out that all embodiments of the present invention relating to a method can be carried out in the described sequence of steps. Nevertheless, this need not be the only possible and necessary order of the steps of the method. The methods described herein may be carried out in a different order of the steps disclosed, without deviating from the corresponding embodiment of the method, unless the contrary is expressly mentioned below.

According to one aspect of the invention, an angled connector for attachment to a shielded cable is proposed. The connector has an upper housing part and a lower housing part. The upper housing part has a bore which is designed to receive the cable the bore being designed to permit a pivoting movement of the upper housing part about the cable and a displacement of the upper housing part along the cable. The lower housing part is designed to accommodate at least one plug contact attached to one end of the cable. Furthermore, the connector has a latching mechanism designed to connect the upper housing part to the lower housing part.

The connector therefore has a two-part outer housing in which an advantageous separation between the two housing parts makes it easy to assemble the components within the connector and simple installation on a cable. The design of the connector can advantageously meet high or the highest sealing requirements such as IP6K9K. This is also possible with a right-angled or almost right-angled cable outlet of preferably 90 degrees. The two-part design of the connector, whereby the upper housing part has a hole at its rear end as a feed-through for the cable and can be moved on the cable with the cable inserted and swiveled to the side of the cable, simple and secure mounting of the connector on the cable is guaranteed. The hole can have a circular diameter that is slightly larger than the outer diameter of the cable to be fitted. This can be used to enable shifting and pivoting. Alternatively, the lower housing part can also have other cross-sections, such as an oblong or oval cross-section. The lower housing part is designed so that it can be tightly connected to a side of the upper housing part opposite the bore. For this purpose, a latching mechanism is provided between the upper housing part and the lower housing part is provided. Between the lower housing part and the upper housing part is a cavity for receiving at least one plug contact, which is attached to one end of the cable. The plug contact is fastened in the lower half of the housing and preferably protrudes from the lower half of the housing in order to be able to establish an electrical contact when connecting the plug connector. The plug connector, is despite its angled cable outlet, easy to assemble and attach to the cable and ensures a high level of impermeability against the ingress of liquids such as water. Preferably, it is a multipole connector with a large number of plug contacts that can be attached to the individual wires of the cable. In a preferred embodiment, the connector is a plug connector that is intended for use in the high-voltage range and/or that is designed for operation with alternating current. Advantageously, the plug connector can provided with a shield for use with shielded cables. The connector can advantageously be used with all multi-part connectors. Different variants of a connector system such as outlet direction, number of poles, shielding or pigtail can be implemented with a connector according to the invention.

In one embodiment of the invention, the connector a sealing device which is designed to seal the upper housing part against the lower housing part. This sealing device can be fitted at the connection point between the upper housing part and the lower housing part and be designed as a circumferential rubber seal. Alternatively, a potting compound can be provided to join the two housing parts together tightly.

In one embodiment of the invention, the plug connector has a contact carrier which is designed to receive the at least one plug contact attached to the end of the line, and the contact carrier is designed to be received in the lower housing part. The contact carrier can thereby function as a connection between the at least one plug contact and the lower housing part. The contacts attached to the cable can thus be inserted into the contact carrier and the contact carrier is mounted in the lower housing section. This enables particularly simplified installation with a large number of plug contacts on a multi-pole cable.

In one embodiment of the invention, the connector has a shield which is designed to be attached to the contact carrier with a first end and to be attached to the line with a second end. In order to ensure uninterrupted shielding of the conductors of the cable, the connector in this embodiment of the invention can be provided with a shield that extends the shielding of the cable over the area within the connector. The shield can be brought into contact with the shielding of the cable and extend to the contact carrier or even beyond.

In one embodiment of the invention, the screen is designed in two parts so that the cable runs between the first part of the shield and the second part of the shield. The two-part design of the shield makes it easy to fit the shield to the cable already connected to the contact carrier. To do this, the two parts of the shield are attached to the cable from opposite sides and connected to each other.

In one embodiment of the invention, the shield is designed to be connected a shielding of the cable at the second end. This ensures the electrical contacting of the shield and thus the earthing of the shield of the plug connector and/or the shielding of the cable.

In one embodiment of the invention, the connector further comprises a seal which is designed to seal the line running through the bore of the upper housing part against the upper housing part, and a strain relief which, when attached to the upper housing part, is designed to prevent displacement of the line through the bore of the upper housing part. Furthermore, the connector has a sealing cap which is designed to be attached to the upper housing part and thereby secure the seal and strain relief to the upper housing part. These components of the connector can be pushed onto the cable before the upper housing part is mounted on the cable. After connecting the upper housing part with the lower part of the housing, the seal can then be slid along the pipe and mounted in the hole of the upper housing part to seal the gap between the cable and the upper housing part. The strain relief is then attached to the upper housing section and fixed to the upper housing section using the sealing cap and clamped onto the cable.

In one embodiment of the invention, the plug connector is designed to bend the cable running through the plug connector between the bore of the upper housing part and the plug contact attached to the end of the cable by an angle of substantially 90°. Preferably, the end of the cable is bent inside the connector which is deflected by an angle of between 45 degrees and 135 degrees, particularly and preferably by an angle of between 80 degrees and 100 degrees. An embodiment of the connector in which the cable is deflected by an angle of approximately 90 degrees is also particularly preferred.

In one embodiment of the invention, the bending of the cable takes place essentially in the area of the shield of the plug connector, and the shield is designed to shield and/or stabilize the cable running inside the shield without an outer insulation of the cable. The deflection of the cable takes place in the area in which the outer insulation of the cable has been removed, and the individual conductors of a multi-pole conductor run freely next to each other. This area is particularly easy to deflect and can be stabilized and shielded against electromagnetic interference by the connector shield.

According to a further aspect of the invention, a method for fastening an angled connector according to one of the preceding embodiments on a shielded cable. The method comprises the steps of attaching the sealing cap, the strain relief and the seal to a shielded cable and inserting the cable through the bore of the upper housing part into the upper housing part. Furthermore, the method comprises the steps of stripping one end of the line, placing a shield on the line, attaching at least one plug contact to the end of the line, mounting the at least one plug contact in the contact carrier, and fastening the shield with the first end to the contact carrier and with the second end to the line. Furthermore, the method comprises the steps of mounting the contact carrier in the lower housing part, the pivoting the upper housing part in order to connect the upper housing part with the lower housing part and mounting the seal, strain relief and sealing cap on the upper housing part. This method allows the connector to be attached to the cable particularly easily and safely.

Thus, the benefits offered by one of the above aspects apply equally to all other aspects and vice versa.

Essentially, the invention relates to an angled connector for attachment to a shielded cable. The connector has an upper housing part and a lower housing part. The upper housing part has a bore which is designed to receive the cable, the bore being designed to permit a pivoting movement of the upper housing part about the cable and a displacement of the upper housing part along the cable. The lower housing part is designed to accommodate at least one plug contact attached to one end of the cable, and the connector has a latching mechanism designed to connect the upper housing part to the lower housing part.

Further features, advantages and possible applications of the invention are apparent from the following description of advantageous embodiments and the accompanying figures.

### BRIEF DESCRIPTION OF THE SEVERAL VIEWS OF THE DRAWINGS

Further advantages, features, and details of the various embodiments of this disclosure will become apparent from the ensuing description of a preferred exemplary embodiment and with the aid of the drawings. The features and combinations of features recited below in the description, as well as the features and feature combination shown after that in the drawing description or in the drawings alone, may be used not only in the particular combination recited, but also in other combinations on their own, without departing from the scope of the disclosure.

In the following, an advantageous embodiment of the invention is explained with reference to the accompanying figures.

FIG. 1 depicts a schematic representation of a connector during a step of an assembly process on a cable according to an embodiment of the invention.

FIG. 2 depicts a schematic representation of a plug connector during a further step of the assembly process on a cable according to an embodiment of the invention.

FIG. 3 depicts a schematic representation of a plug connector during a further step of the assembly process on a cable according to an embodiment of the invention.

FIG. 4 depicts a schematic representation of a connector during a further step of the assembly process on a cable according to an embodiment of the invention.

FIG. 5 depicts a schematic representation of a plug connector during another step of the assembly process on a cable according to one embodiment of the invention.

FIG. 6 depicts a schematic representation of a plug connector mounted on a cable according to one embodiment of the invention.

FIG. 7 depicts a block diagram of a method for fastening an angled connector according to one embodiment of the invention on a shielded cable.

The figures are merely schematic representations and serve only to explain the invention. Identical or similarly acting elements are consistently provided with the same reference signs.

### DETAILED DESCRIPTION OF THE INVENTION

As used throughout the present disclosure, unless specifically stated otherwise, the term “or” encompasses all possible combinations, except where infeasible. For example, the expression “A or B” shall mean A alone, B alone, or A and B together. If it is stated that a component includes “A, B, or C”, then, unless specifically stated otherwise or infeasible, the component may include A, or B, or C, or A and B, or A and C, or B and C, or A and B and C. Expressions such as “at least one of” do not necessarily modify an entirety of the following list and do not necessarily modify each member of the list, such that “at least one of “A, B, and C” should be understood as including only one of A, only one of B, only one of C, or any combination of A, B, and C.

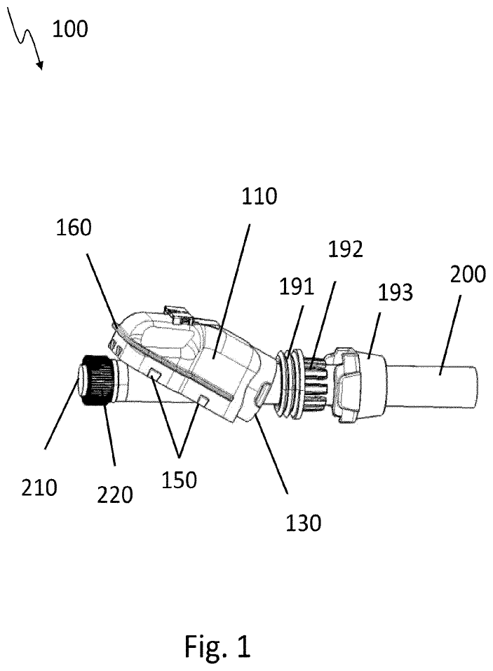

FIG. 1 shows a schematic representation of a connector 100 during a step of an assembly process on a line 200 according to an embodiment of the invention. On the line 200, for example an HV line, sealing caps 193, strain relief 192 and seal 191 are pre-assembled. Subsequently, the upper housing part 110 of the outer housing of the plug connector 100 is also pushed onto the cable 200, whereby the cable 200 is guided through the bore 130 of the upper housing part 110. In this embodiment of the invention, the upper housing part 110 has a latching mechanism 150 with which it is connected to the lower housing part 120, as well as a sealing device 160 with which a sealed connection can be produced between the upper housing part 110 and the lower housing part 120. The shielding 220 of the cable 200 can be seen at the end 210 of the cable 200 to which the plug connector 100 is to be attached.

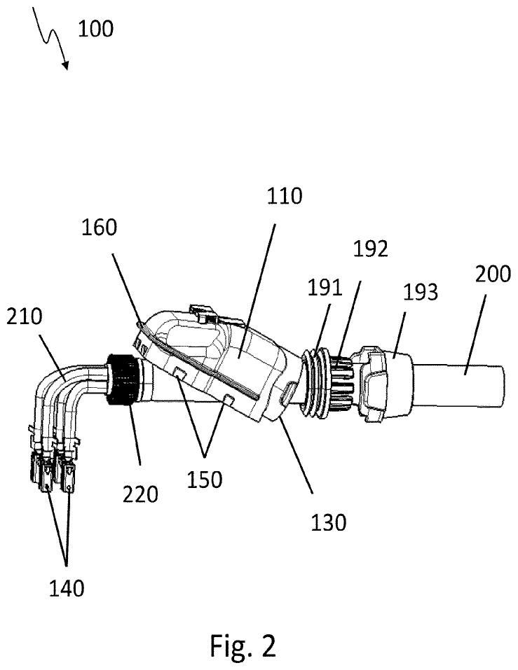

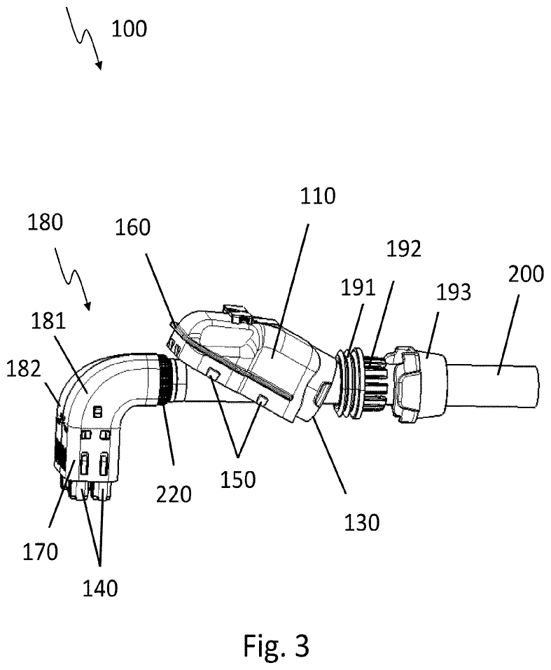

FIG. 2 shows a schematic representation of a plug connector 100 during a further step of the assembly process on a cable 200 according to an embodiment of the invention. In comparison to the assembly step shown in FIG. 1, the end 220 of the cable 200 is stripped here, so that the individual conductors are visible, and the shielding 220 is folded over. A plug contact 140 is connected to each of the conductors with the conductors having a bend of approximately 90 degrees. FIG. 3 shows a schematic representation of a plug connector 100 during a further step of the assembly process on a cable 100 according to an embodiment of the invention. Here, the plug contacts 140 are inserted into the contact carrier 170 and the two-part shield 180 with the first part of the shield 181 and the second part of the shield 182 is clipped to the contact carrier and pressed onto the cable 200, preferably onto the shielding 220 of the cable 200.

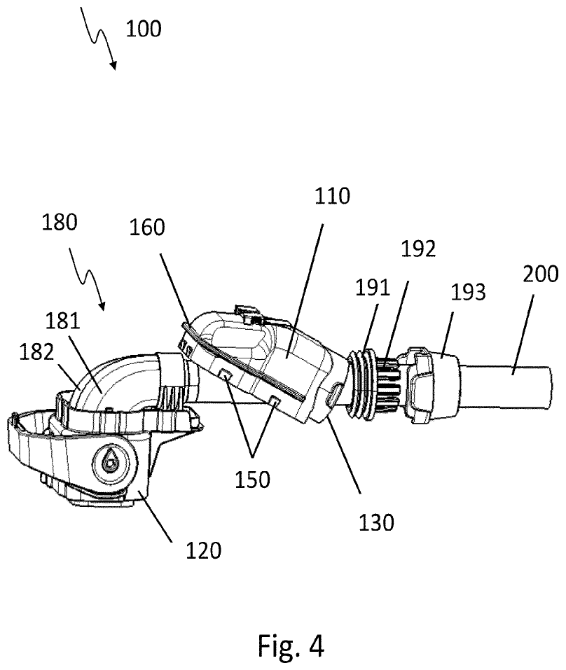

FIG. 4 shows a schematic representation of a plug connector 100 during a further step of the assembly process on a cable 200 according to an embodiment of the invention. The pre-assembled system comprising the contact carrier 170 with the plug contacts 140 arranged therein, which are attached to the cable 200, is mounted in the lower housing part 120. Preferably, the contact carrier 170 is pre-fixed in the lower housing part 120, for example by a latching mechanism.

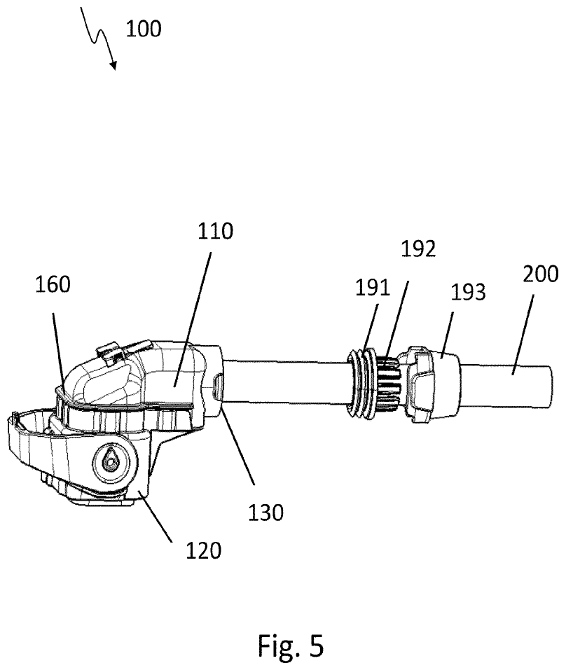

FIG. 5 shows a schematic representation of a connector 100 during a further step of the assembly process on a cable 200 according to an embodiment of the invention. The upper housing part 110 is moved along the line 200 and placed over the two-part shield 180 so that it can be connected to the lower housing part 120 by means of the locking mechanism 150. The sealing device 160 ensures that the two housing parts fit tightly together.

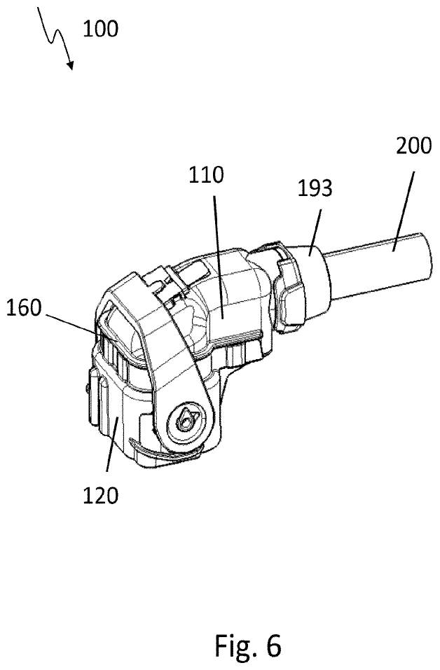

FIG. 6 shows a schematic representation of a connector 100 mounted on a line 200 according to an embodiment of the invention Here, the seal 191, the strain relief 192 and the sealing cap 193 are mounted on the upper housing part 110.

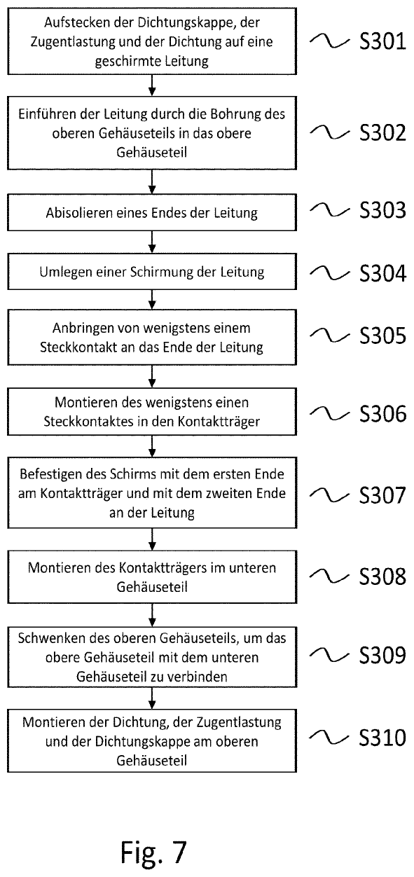

FIG. 7 shows a block diagram of a method for attaching an angled connector 100, according to an embodiment of the invention, to a shielded cable 200. The step S301 of attaching the sealing cap 193, the strain relief 192 and the seal 191 to a shielded cable 200 is followed by the step S302 of inserting the cable 200 through the hole 130 of the upper housing part 110 into the upper housing part 110, and the step S303 of stripping one end 210 of the shielded cable 200. In step S304, a shielding 220 of the cable 200 is switched, and in step S304 a shielding 220 of the cable 200 is switched. Step S305 attaches at least one plug-in contact 140 to the end 210 of the cable 220. This is followed by step S306 of mounting the at least one plug-in contact 140 in the contact carrier 170, as well as step S307 of fastening the shield 180 with the first end to the contact carrier 170 and with the second end to the cable 200, and step S307 of fastening the shield 180 with the second end to the cable 200. and step S308 of mounting the contact carrier 170 in the lower housing part 120. This is followed by step S309 of pivoting the upper housing part 110 to connect the upper housing part 110 to the lower housing part 120, and step S310 of mounting the gasket 191, the strain relief 192 and the sealing cap 193 on the upper housing part 110.

Although the invention has been illustrated and described in detail in the drawings and the foregoing description, these drawings and descriptions are to be understood as illustrative or exemplary and are not to be limiting. The invention is not to the disclosed embodiments. Other variations of the disclosed. Embodiments may be understood and carried out by those skilled in the art the claimed invention with reference to the drawings, the disclosure and the dependent claims.

It should also be noted that “comprehensive” does not include any other elements or steps. and “one” or “a” does not exclude a plurality. Furthermore, it should be noted that features or steps described with reference to one of the above embodiments may also be used in combination with other features or steps of other embodiments described above. Reference signs in the claims are not to be regarded as a limitation.

What is claimed is:

1. An angled connector configured to attach to a shielded cable, the angled connector comprising:
an upper housing part; and
a lower housing part;
wherein the upper housing part comprises a bore configured to receive the shielded cable, and wherein the bore is further configured to enable a pivoting movement of the upper housing part about the shielded cable and a displacement of the upper housing part along the shielded cable,
wherein the lower housing part is configured to receive at least one plug contact attached to one end of the shielded cable,
wherein the angled connector further comprises a latching mechanism configured to connect the upper housing part to the lower housing part;
wherein the angled connector further comprises a sealing device arranged and configured to seal the upper housing portion against the lower housing portion, and
wherein the angled connector further comprises:
a seal configured to seal the conduit extending through the bore of the upper housing portion against the upper housing portion,
a strain relief which, when attached to the upper housing part, is configured to prevent displacement of the shielded cable through the bore of the upper housing part, and
a sealing cap configured to be secured to the upper housing part and thereby secure the seal and the strain relief to the upper housing part.

2. (canceled)

3. The angled connector according to claim 1, further comprising a contact carrier configured and arranged to receive at least one plug contact attached to the end of the shielded cable, and wherein the contact carrier is configured to be received in the lower housing part.

4. The angled connector according to claim 3, further comprising a shield having a first end and a second end, the shield configured to be attached to the contact carrier with the first end and to be attached to the shielded cable with the second end.

5. The angled connector according to claim 3, wherein the shield comprises two parts configured and arranged such that the shielded cable runs between the first part and the second part.

6. The angled connector according to claim 4, wherein the shield is configured to be connected to the second end with a shield of the shielded cable.

7. (canceled)

8. The angled connector according to claim 1, wherein the angled connector is configured to bend the shielded conductor running through the angled connector between the bore of the upper housing part and the plug contact attached to the end of the line at an angle of substantially 90°.

9. The angled connector according to claim 5, wherein the bending of the line occurs substantially in a region of the shield of the angled connector, and wherein the shield is configured and arranged to shield and/or stabilize the shielded conductor running inside the shield without external insulation of the line shielded conductor.

10. (canceled)

11. The angled connector according to claim 5, wherein the shield is configured to be connected to the second end with a shield of the shielded cable.

12. The angled connector according to claim 4, wherein the bending of the line occurs substantially in a region of the shield of the angled connector, and wherein the shield is configured and arranged to shield and/or stabilize the shielded conductor running inside the shield without external insulation of the line shielded conductor.

13. The angled connector according to claim 5, wherein the bending of the line occurs substantially in a region of the shield of the angled connector, and wherein the shield is configured and arranged to shield and/or stabilize the shielded conductor running inside the shield without external insulation of the line shielded conductor.

14. The angled connector according to claim 6, wherein the bending of the line occurs substantially in a region of the shield of the angled connector, and wherein the shield is configured and arranged to shield and/or stabilize the shielded conductor running inside the shield without external insulation of the line shielded conductor.
